(19) United States
(12) Patent Application Publication
(10) Pub. No.: US 2011/0181113 A1
(43) Pub. Date: Jul. 28, 2011

(54) FUEL CELL SYSTEM AND POWER MANAGEMENT METHOD THEREOF

(75) Inventors: Kuo-Tai Hung, Hsinchu County (TW); Ken-Chih Chang, Hsinchu County (TW)

(73) Assignee: YOUNG GREEN ENERGY CO., HSINCHU COUNTY (TW)

(21) Appl. No.: 13/005,537

(22) Filed: Jan. 13, 2011

(30) Foreign Application Priority Data
Jan. 26, 2010 (CN) 201010104053.X

(51) Int. Cl. H02J 1/14; H02J 7/34

(52) U.S. Cl. 307/34

(57) ABSTRACT

A fuel cell system including a fuel cell power generator, a first state detecting unit, an electronic load circuit, an external load power supply circuit, a secondary battery, a charge module, and a control unit is provided. The first state detecting unit detects an output voltage and an output power of the fuel cell power generator. The electronic load circuit performs a current-sinking operation on the fuel cell power generator. The external load power supply circuit receives a power from the fuel cell power generator and supplies the power to an external load. The control unit controls the current-sinking operation of the electronic load circuit according to the detection result of the first state detecting unit, so as to adjust the output voltage of the fuel cell power generator and enable at least one of the electronic load circuit, the charge module, and the external load power supply circuit.

### CROSS-REFERENCE TO RELATED APPLICATION

This application claims the priority benefit of China application serial no. 201010104053.X, filed on Jan. 26, 2010. The entirety of the above-mentioned patent application is hereby incorporated by reference herein and made a part of this specification.

### BACKGROUND OF THE INVENTION

1. Field of the Invention

The invention generally relates to a power supply system, and more particularly, to a fuel cell system and a power management method thereof

2. Description of Related Art

The exploitation and application of energy sources have always been a critical part of human life. Conventional techniques for exploiting and applying energy sources have caused vast environmental damage. The fuel cell technique is a highly efficient, low-noise, and non-polluting energy generation technique and complies with the energy-saving trend. Since a fuel cell is a soft-start power generation device and may achieve its maximum rated output power after it is started for some time, the output power of the fuel cell is less than its maximum rated output power when the temperature and density do not satisfy a specific condition. At the beginning of operation, a fuel cell is not used for supplying power to any external load because it only supplies very low power. If a fuel cell is used for supplying power to an external load, the fuel cell instantly outputs the maximum power, which damages itself.

A power management method of a fuel cell is disclosed in Taiwan Patent No. 200743240, a hybrid power supply device and a power management method thereof are disclosed in Taiwan Patent No. 1274454, and an electronic load device that offers a stabilized load current within a wide range is disclosed in Taiwan Patent No. 200431061.

In the Taiwan Patent No. 200743240, when a fuel cell system is in operation, a fuel cell power generator supplies enough power to the load but the residual power is not enough for the entire system. As a result, it is not only using energy ineffectively but also taking extra time to charge an internal secondary battery and shut-down time. Additionally, in aforementioned conventional techniques, the fuel cell power generator supplies lower power when a fuel cell system starts to work initially and therefore it is not used for supplying power to the system or any external load and energy is not able to be effectively used. Moreover, in aforementioned conventional techniques, because the fuel cell instantly outputs the maximum power when the fuel cell just starts to supply power, the fuel cell power generator may be damaged.

### SUMMARY OF THE INVENTION

Accordingly, the invention is directed to a fuel cell system and a power management method thereof, wherein the output power of a fuel cell is prevented from being instantly pulled up so that the fuel cell is protected from the damage.

Additional aspects and advantages of the invention will be set forth in following description of the invention.

According to an embodiment of the invention, a fuel cell system including a fuel cell power generator, a first state detecting unit, an electronic load circuit, an external load power supply circuit, a secondary battery, a charge module, and a control unit is provided. The first state detecting unit is capable of detecting a power generated by the fuel cell power generator so as to obtain an output voltage and an output power of the fuel cell power generator. The electronic load circuit is coupled to the fuel cell power generator and is capable of performing a current-sinking operation on the fuel cell power generator. The external load power supply circuit is coupled to the fuel cell power generator and is capable of receiving the power generated by the fuel cell power generator so as to supply power to an external load. The charge module is coupled to the fuel cell power generator and is capable of adjusting a charge current of the secondary battery. The control unit is coupled to the electronic load circuit, the external load power supply circuit, and the charge module. The control unit is capable of controlling the value of the sinking current of the electronic load circuit according to a detection result of the first state detecting unit, so as to adjust the output voltage of the fuel cell power generator, and the control unit is capable of enabling at least one of the electronic load circuit, the external load power supply circuit, and the charge module according to the output power of the fuel cell power generator.

According to an embodiment of the invention, a power management method of a fuel cell system is provided, wherein the fuel cell system includes a fuel cell power generator and a secondary battery. The power management method includes following steps. Whether the fuel cell power generator loads a current and an output voltage of the fuel cell power generator are detected, and a charge current of the secondary battery is adjusted according to the output voltage. The output voltage of the fuel cell power generator is detected and compared with an operating voltage of the fuel cell power generator, and the sinking current of the fuel cell power generator is adjusted according to a result of the comparison. An output power of the fuel cell power generator is detected and compared with a rated power of an external load, and whether the fuel cell power generator supplies a power to the external load is determined according to the result of the comparison.

According to an embodiment of the invention, the control unit enables the external load power supply circuit and disables the electronic load circuit and the charge module when the output power is equal to the rated power of the external load.

According to an embodiment of the invention, the control unit enables the electronic load circuit and the charge module and disables the external load power supply circuit when the output power is less than the rated power of the external load.

According to an embodiment of the invention, the control unit enables the electronic load circuit, the charge module, and the external load power supply circuit when the output power is greater than the rated power of the external load.

According to an embodiment of the invention, the electronic load circuit includes a first conversion unit, a first operational amplifier, a first transistor, a first resistor, a second resistor, and a third resistor. The first conversion unit is coupled to the control unit and converts a first pulse width modulation (PWM) signal output from the control unit into an analog voltage. The positive input terminal of the first operational amplifier is coupled to the output terminal of the first conversion unit. The drain of the first transistor is coupled to the fuel cell power generator, and the source of the first transistor is coupled to the negative input terminal of the first operational amplifier. The first resistor is coupled between the output terminal of the first operational amplifier and the gate of the first transistor. The second resistor is coupled between the source of the first transistor and a ground voltage. The third resistor is coupled between the output terminal of the first operational amplifier and the ground voltage.

According to an embodiment of the invention, the control unit adjusts the duty cycle of the first PWM signal so as to control the value of the analog voltage.

According to an embodiment of the invention, the charge module includes a charging circuit and a control circuit. The charging circuit is coupled to the fuel cell power generator and the control unit. The control circuit is coupled to the charging circuit and the secondary battery. The fuel cell power generator charges the secondary battery through the charging circuit when the charging circuit is enabled by the control unit, and the control circuit adjusts the charge current of the secondary battery when the control circuit is enabled by the control unit.

According to an embodiment of the invention, the charge module further includes an internal load power supply circuit coupled to the secondary battery, wherein the internal load power supply circuit receives the electric power stored in the secondary battery and supplies the electric power to an internal load of the fuel cell system.

According to an embodiment of the invention, the charge module further includes a second state detecting unit coupled to the secondary battery and the control unit, wherein the second state detecting unit detects a storage voltage of the secondary battery, and the control unit enables the charge module according to the storage voltage of the secondary battery so as to adjust the charge current of the secondary battery.

According to an embodiment of the invention, the first conversion unit includes a fourth resistor, a first capacitor, a fifth resistor, and a second capacitor. The fourth resistor is coupled to the control unit. The first capacitor is coupled between the fourth resistor and the ground voltage. The fifth resistor is coupled between the fourth resistor and the output terminal of the first conversion unit. The second capacitor is coupled between the output terminal of the first conversion unit and the ground voltage.

According to an embodiment of the invention, the control circuit includes a second conversion unit, a second operational amplifier, a second transistor, a sixth resistor, a seventh resistor, an eighth resistor, and a ninth resistor. The second conversion unit is coupled to the control unit and converts a second PWM signal output from the control unit into an analog voltage. The positive input terminal of the second operational amplifier is coupled to the output terminal of the first conversion unit. The drain of the second transistor is coupled to the charging circuit, and the source of the second transistor is coupled to the secondary battery. The sixth resistor is coupled between the output terminal of the second operational amplifier and the gate of the second transistor. The seventh resistor is coupled between the negative input terminal of the second operational amplifier and the gate of the second transistor. The eighth resistor is coupled between the negative input terminal of the second operational amplifier and the ground voltage. The ninth resistor is coupled between the positive input terminal of the second operational amplifier and the ground voltage.

According to an embodiment of the invention, the control unit adjusts the duty cycle of the second PWM signal so as to control the value of the analog voltage.

According to an embodiment of the invention, the second conversion unit includes a tenth resistor, a third capacitor, an eleventh resistor, and a fourth capacitor. The tenth resistor is coupled to the control unit. The third capacitor is coupled between the tenth resistor and the ground voltage. The eleventh resistor is coupled between the tenth resistor and the output terminal of the second conversion unit. The fourth capacitor is coupled between the output terminal of the second conversion unit and the ground voltage.

As described above, an embodiment of the invention has at least one of following advantages. According to an embodiment of the invention, a current-sinking operation is performed on a fuel cell power generator and the charge current of a secondary battery is adjusted by using an electronic load circuit and a control circuit. Thus, the output power of the fuel cell power generator is prevented from being pulled up instantly and the fuel cell is protected from the damage. Besides, the electric power generated by the active fuel cell power generator is effectively used, and accordingly the energy consumption is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a fuel cell system according to an embodiment of the invention.

FIG. 2 is a diagram of a fuel cell system according to an embodiment of the invention.

FIG. 3 is a circuit diagram of a control circuit according to an embodiment of the invention.

FIG. 4 is a circuit diagram of an electronic load circuit according to an embodiment of the invention.

FIG. 5 is a flowchart of a power management method of a fuel cell system according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

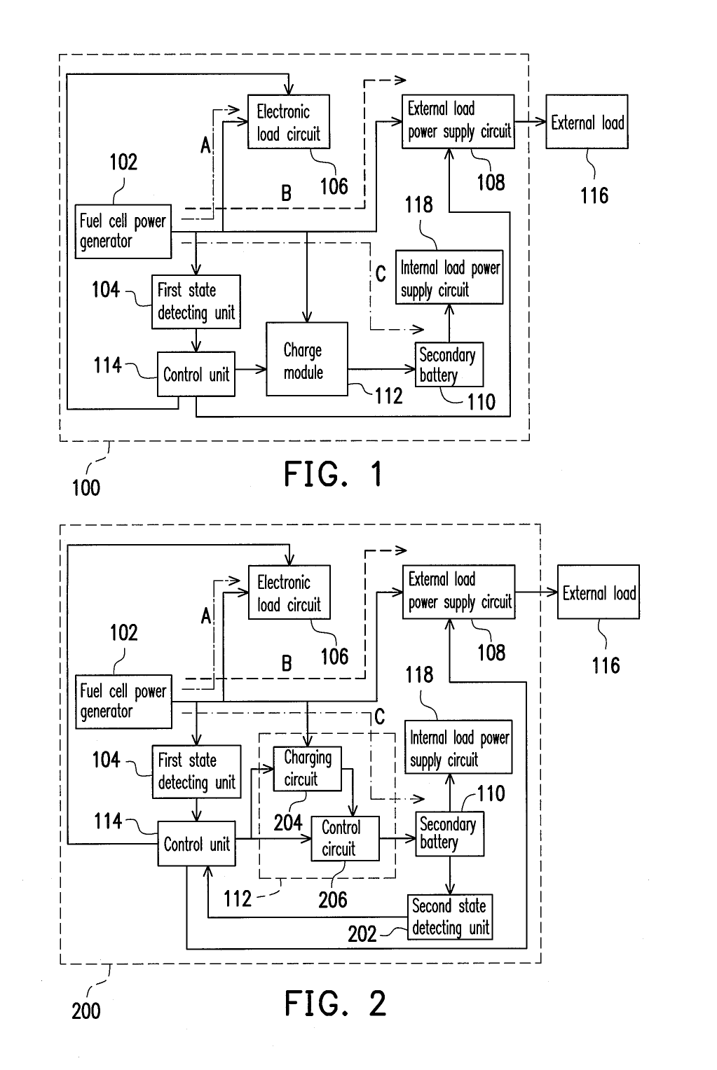

FIG. 1 is a diagram of a fuel cell system according to an embodiment of the invention. Referring to FIG. 1, the fuel cell system 100 includes a fuel cell power generator 102, a first state detecting unit 104, an electronic load circuit 106, an external load power supply circuit 108, a secondary battery 110, a charge module 112, and a control unit 114. The first state detecting unit 104 is coupled to the fuel cell power generator 102 and detects characteristics of the power generated by the fuel cell power generator 102, such as the output voltage or the output power of the fuel cell power generator 102. The electronic load circuit 106 is coupled to the fuel cell power generator 102 and the control unit 114. The electronic load circuit 106 performs a current-sinking operation on the fuel cell power generator 102 to prevent the output power of the fuel cell power generator 102 from being pulled up instantly, so that the fuel cell power generator 102 may not be damaged and the lifespan of the fuel cell power generator 102 is prolonged. The external load power supply circuit 108 is coupled to the fuel cell power generator 102 and the control unit 114. The external load power supply circuit 108 receives the electric power generated by the fuel cell power generator 102 and supplies the electric power to an external load 116. The charge module 112 is coupled to the fuel cell power generator 102, the secondary battery 110, and the control unit 114. The charge module 112 adjusts the charge current of the fuel cell power generator 102 supplied to the secondary battery 110.

The control unit 114 enables the electronic load circuit 106 and the charge module 112 according to the output voltage of the fuel cell power generator 102 detected by the first state detecting unit 104. The control unit 114 enables the external load power supply circuit 108 according to the output power of the fuel cell power generator 102 detected by the first state detecting unit 104, so as to determine whether to supply power to the external load 116. When the fuel cell power generator 102 starts to generate electric power, because it takes some time to activate the output power of the fuel cell power generator 102 to achieve the rated power of the external load 116, the control unit 114 controls the electronic load circuit 106 to slowly load current into the fuel cell power generator 102 according to the output voltage of the fuel cell power generator 102 detected by the first state detecting unit 104 during the activation period, so as to protect the fuel cell power generator 102 from any damage. When the output voltage of the fuel cell power generator 102 is greater than the operating voltage of the fuel cell power generator 102, the control unit 114 controls the electronic load circuit 106 to increase the sinking current of the fuel cell power generator 102. Contrarily, when the output voltage of the fuel cell power generator 102 is less than the operating voltage of the fuel cell power generator 102, the control unit 114 controls the electronic load circuit 106 to decrease the sinking current of the fuel cell power generator 102.

On the other hand, during the activation period of the fuel cell power generator 102, the control unit 114 also controls the charge module 112 according to the output voltage of the fuel cell power generator 102 detected by the first state detecting unit 104, so as to adjust the charge current of the secondary battery 110. When the first state detecting unit 104 detects that the electronic load circuit 106 performs a current-sinking operation on the fuel cell power generator 102 and that the output voltage of the fuel cell power generator 102 is within a predetermined voltage range (i.e., the output voltage of the fuel cell power generator 102 is sufficient for charging the secondary battery 110), the control unit 114 controls the charge module 112 to increase the charge current of the secondary battery 110, so as to charge the secondary battery 110. If the electronic load circuit 106 stops loading the current into the fuel cell power generator 102 and the output voltage of the fuel cell power generator 102 exceeds the predetermined voltage range (i.e., the output voltage of the fuel cell power generator 102 exceeds the range for charging the secondary battery 110), the control unit 114 controls the charge module 112 to decrease the charge current of the secondary battery 110. Accordingly, the electric power generated by the fuel cell power generator 102 during the activation period is stored in the secondary battery 110 and the energy consumption is reduced. The electric power stored in the secondary battery 110 could be supplied to an internal load power supply circuit 118 coupled to the secondary battery 110, so that the internal load power supply circuit 118 could supply the electric power stored in the secondary battery 110 to internal devices of the fuel cell system 100. Thus, the current generated by the fuel cell power generator 102 during the activation period could flow to the electronic load circuit 106 along a current path A and to the secondary battery 110 through the charge module 112 along a current path C.

When the first state detecting unit 104 detects that the output power of the fuel cell power generator 102 increases to the rated power of the external load 116, the control unit 114 disables the electronic load circuit 106 and the charge module 112, so as to stop the current loading and charging operations (i.e., shut off the current paths A and C), and meanwhile, the control unit 114 enables the external load power supply circuit 108 so as to supply the electric power generated by the fuel cell power generator 102 to the external load 116 through the external load power supply circuit 108. Herein the electric power generated by the fuel cell power generator 102 is supplied along the current path B.

Along with the elapse of the activation time of the fuel cell power generator 102, the output power of the fuel cell power generator 102 gradually increases and eventually exceeds the rated power of the external load 116. In this case, the control unit 114 enables the electronic load circuit 106 and the charge module 112 again so as to control the output power of the fuel cell power generator 102 and supply the excess power generated by the fuel cell power generator 102 to the secondary battery 110 to charge the secondary battery 110. By enabling and disabling the electronic load circuit 106, the external load power supply circuit 108, and the charge module 112 as described above, the current path for conducting the current generated by the fuel cell power generator 102 is changed, so that not only the output power of the fuel cell power generator 102 is prevented from being instantly pulled up, but the electric power generated by the fuel cell power generator 102 during the activation period is effectively used and accordingly energy consumption is reduced.

FIG. 2 is a diagram of a fuel cell system according to an embodiment of the invention. Referring to FIG. 2, the difference between the fuel cell system 200 in the embodiment and the fuel cell system 100 in the embodiment illustrated in FIG. 1 is that the fuel cell system 200 further includes a second state detecting unit 202, and the charge module 112 includes a charging circuit 204 and a control circuit 206. The second state detecting unit 202 is coupled to the secondary battery 110 and the control unit 114, and the charging circuit 204 is coupled to the control unit 114, the fuel cell power generator 102, and the control circuit 206. The control circuit 206 is coupled to the control unit 114 and the secondary battery 110. The second state detecting unit 202 detects the status of the secondary battery 110 and provides the detection result to the control unit 114. The control unit 114 determines whether to enable the charging circuit 204 according to the status of the secondary battery 110, so as to prevent the secondary battery 110 from being over-charged or under-charged. The charging circuit 204 may be a switch, and the control circuit 206 adjusts the charge current of the secondary battery 110.

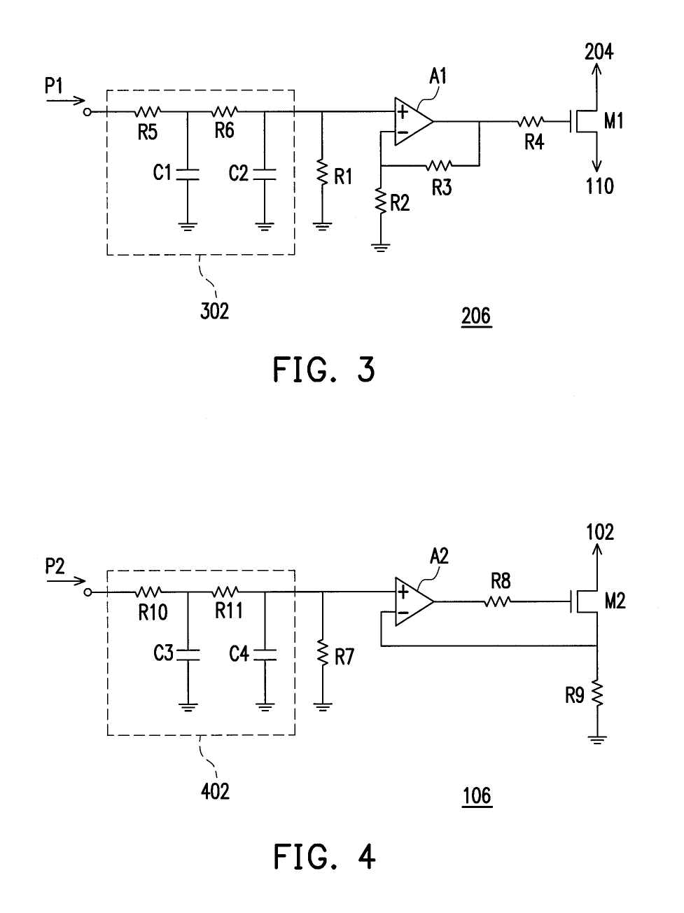

It should be noted that in the embodiment, the control unit 114 may be a microcontroller, and which indirectly adjusts the value of the charge current of the secondary battery 110 by controlling the control circuit 206. The control circuit 206 may be implemented according to the embodiment illustrated in FIG. 3. FIG. 3 is a circuit diagram of a control circuit according to an embodiment of the invention. Referring to FIG. 3, the control circuit 206 includes a conversion unit 302, an operational amplifier A1, a transistor M1, and resistors R1-R4. The transistor M1 may be an N-type metal-oxide-semiconductor (NMOS) transistor. The conversion unit 302 is coupled to the positive input terminal of the operational amplifier A1. The resistor R1 is coupled between the positive input terminal of the operational amplifier A1 and a ground voltage. The resistor R2 is coupled between the negative input terminal of the operational amplifier A1 and the ground voltage. The resistor R3 is coupled between the negative input terminal and the output terminal of the operational amplifier A1. The resistor R4 is coupled between the output terminal of the operational amplifier A1 and the gate of the transistor M1. The drain and source of the transistor M1 are respectively coupled to the charging circuit 204 and the secondary battery 110.

When the control unit 114 detects that the electronic load circuit 106 performs the current-sinking operation on the fuel cell power generator 102 (i.e., the control unit 114 sends a pulse width modulation (PWM) signal to the electronic load circuit 106), namely, when the output voltage of the fuel cell power generator 102 is less or greater than the operating voltage of the fuel cell power generator 102, the control unit 114 sends a PWM signal P1 to the conversion unit 302. In the embodiment, the conversion unit 302 is implemented by using resistors R5 and R6 and capacitors C1 and C2. The resistor R5 is coupled to the control unit 114 and the resistor R6, and the resistor R6 is coupled between the resistor R5 and the positive input terminal of the operational amplifier A1. The capacitor C1 is coupled between the junction of the resistors R5 and R6 and the ground voltage, and the capacitor C2 is coupled between the positive input terminal of the operational amplifier A1 and the ground voltage. The control unit 114 controls the analog output voltage of the conversion unit 302 (i.e., the voltage on the positive input terminal of the operational amplifier A1) by adjusting the duty cycle of the PWM signal P1.

When the control unit 114 increases the charge current of the secondary battery 110, the control unit 114 increases the duty cycle of the PWM signal P1 so that the voltage on the positive input terminal of the operational amplifier A1 is increased and accordingly the voltage on the output terminal of the operational amplifier A1 is also increased. Thus, the voltage between the gate and the source of the transistor M1 is also increased, so that the channel of the transistor M1 is widened, and the current running through the transistor M1 is increased. Contrarily, if the duty cycle of the PWM signal P1 is decreased, the voltage on the positive input terminal of the operational amplifier A1 is decreased, and accordingly the voltage on the output terminal of the operational amplifier A1 is also decreased. Thus, the voltage between the gate and the source of the transistor M1 is decreased, so that the channel of the transistor M1 is narrowed, and the current running through the transistor M1 is decreased. Thereby, the charge current of the secondary battery 110 could be controlled by adjusting the duty cycle of the PWM signal P1.

FIG. 4 is a circuit diagram of an electronic load circuit according to an embodiment of the invention. Referring to FIG. 4, the electronic load circuit 106 includes a conversion unit 402, an operational amplifier A2, a transistor M2, and resistors R7-R9. The transistor M2 may be a NMOS transistor. The conversion unit 402 is coupled to the positive input terminal of the operational amplifier A2. The resistor R7 is coupled between the positive input terminal of the operational amplifier A2 and the ground voltage. The negative input terminal of the operational amplifier A1 is coupled to the source of the transistor M2. The resistor R8 is coupled between the output terminal of the operational amplifier A2 and the gate of the transistor M2. The drain and the source of the transistor M2 are respectively coupled to the fuel cell power generator 102 and the resistor R9, and another end of the resistor R9 is coupled to the ground voltage.

When the control unit 114 detects that the output voltage of the fuel cell power generator 102 is not equal to the operating voltage of the fuel cell power generator 102, the control unit 114 sends a PWM signal P2 to the conversion unit 402, so as to load a current into the fuel cell power generator 102. In the embodiment, the conversion unit 402 is implemented by using resistors R10 and R11 and capacitors C3 and C4. The resistor R10 is coupled to the control unit 114 and the resistor R11, and the resistor R11 is coupled between the resistor R10 and the positive input terminal of the operational amplifier A2. The capacitor C3 is coupled between the junction of the resistors R10 and R11 and the ground voltage, and the capacitor C4 is coupled between the positive input terminal of the operational amplifier A2 and the ground voltage. The control unit 114 controls the analog output voltage of the conversion unit 402 (i.e., the voltage on the positive input terminal of the operational amplifier A1) by adjusting the duty cycle of the PWM signal P2.

When the control unit 114 increases the sinking current of the fuel cell power generator 102 loaded by the electronic load circuit 106, it increases the duty cycle of the PWM signal P2 so that the voltage on the positive input terminal of the operational amplifier A2 is increased and the voltage on the output terminal of the operational amplifier A2 is also increased. Thus, the voltage between the gate and the source of the transistor M2 is also increased, so that the channel of the transistor M2 is widened and the current running through the transistor M2 is increased. Contrarily, if the duty cycle of the PWM signal P2 is decreased, the voltage on the positive input terminal of the operational amplifier A2 is decreased, and the accordingly the voltage on the output terminal of the operational amplifier A2 is also decreased. Thus, the voltage between the gate and source of the transistor M2 is also decreased, so that the channel of the transistor M2 is narrowed and the current running through the transistor M2 is decreased. Thereby, the sinking current of the fuel cell power generator 102 loaded by the electronic load circuit 106 could be controlled by adjusting the duty cycle of the PWM signal P2. Additionally, because the positive input terminal and negative input terminal of the operational amplifier A2 are virtually grounded, the voltage on the positive input terminal of the operational amplifier A2 is equal to the voltage on the negative input terminal thereof. On the other hand, because the resistor R9 is coupled to the negative input terminal of the operational amplifier A2, the sinking current of the fuel cell power generator 102 flows toward the ground voltage through the transistor M2 and the resistor R9, so that a constant current loading effect is achieved.

The output voltage of the fuel cell power generator 102 is decreased when the sinking current of the fuel cell power generator 102 is increased. Contrarily, the output voltage of the fuel cell power generator 102 is increased when the sinking current of the fuel cell power generator 102 is decreased. Thus, the output voltage of the fuel cell power generator 102 could be adjusted to be within an appropriate voltage range by adjusting the sinking current of the fuel cell power generator 102.

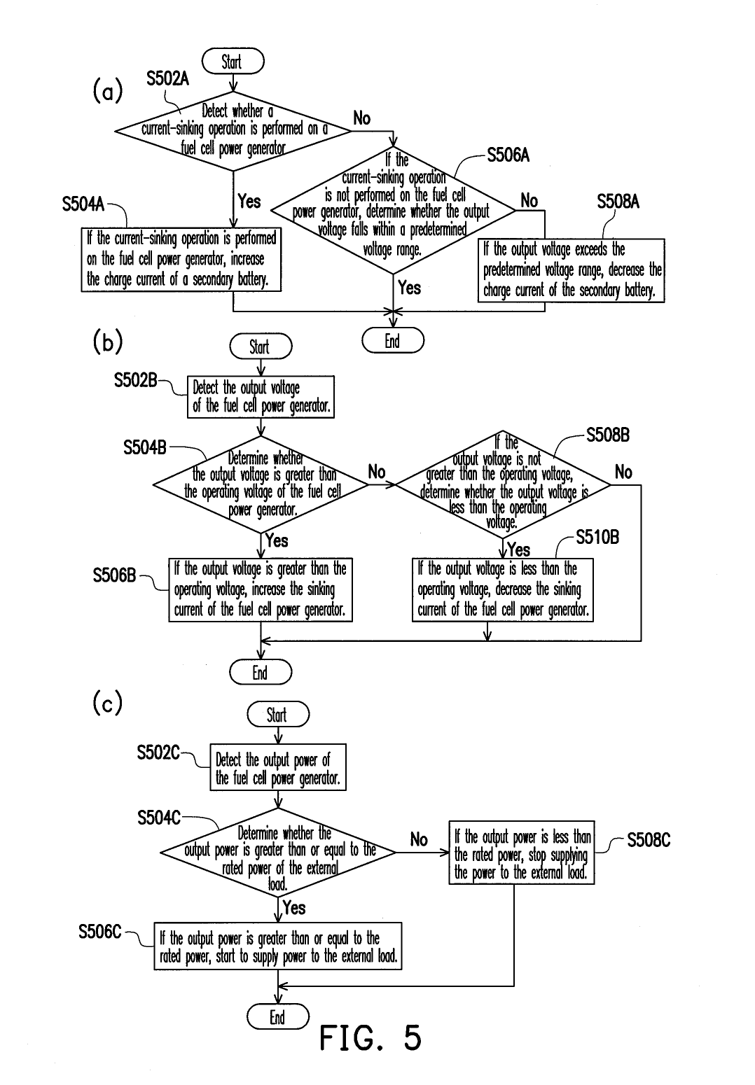

FIG. 5 is a flowchart of a power management method of a fuel cell system according to an embodiment of the invention. Referring to FIG. 5, the power management method of the fuel cell system could be summarized into following steps (a), (b), and (c).

In step (a), it is detected whether a current-sinking operation is performed on the fuel cell power generator (step S502A). If the current-sinking operation is performed on the fuel cell power generator, the charge current of the secondary battery is increased (step S504A). If the current-sinking operation is not performed on the fuel cell power generator, it is determined whether the output voltage of the fuel cell power generator falls within a predetermined voltage range (step S506A). If the output voltage of the fuel cell power generator exceeds the predetermined voltage range, the charge current of the secondary battery is decreased (step S508A). If the output voltage of the fuel cell power generator is within the predetermined voltage range, the step (a) is ended.

In step (b), the output voltage of the fuel cell power generator is detected (step S502B). Then, it is determined whether the output voltage of the fuel cell power generator is greater than the operating voltage of the fuel cell power generator (step S504B). If the output voltage of the fuel cell power generator is greater than the operating voltage of the fuel cell power generator, the sinking current of the fuel cell power generator is increased (step S506B). If the output voltage of the fuel cell power generator is not greater than the operating voltage of the fuel cell power generator, whether the output voltage of the fuel cell power generator is less than the operating voltage of the fuel cell power generator is determined (step S508B). If the output voltage of the fuel cell power generator is less than the operating voltage of the fuel cell power generator, the sinking current of the fuel cell power generator is decreased (step S510B).

In step (c), first, the output power of the fuel cell power generator is detected (step S502C). Next, it is determined whether the output power of the fuel cell power generator is greater than or equal to the rated power of the external load (step S504C). If the output power of the fuel cell power generator is greater than or equal to the rated power of the external load, a power is supplied to the external load (step S506C). If the output power of the fuel cell power generator is less than the rated power of the external load, the power is not supplied to the external load anymore (step S508C).

Additionally, it should be noted that in the embodiment, the steps (a), (b), and (c) are sequentially executed at a predetermined interval so as to improve the power management performance of the fuel cell system.

As described above, an embodiment of the invention has at least one of following advantages. According to an embodiment of the invention, a sinking current of a fuel cell power generator and the charge current of a secondary battery are adjusted by using an electronic load circuit and a control circuit. Thus, the output power of the fuel cell power generator is prevented from being pulled up instantly and the fuel cell is protected from the damage. Besides, the electric power generated by the active fuel cell power generator is effectively used, and accordingly the energy consumption is reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A fuel cell system, comprising:
a fuel cell power generator;
a first state detecting unit, capable of detecting a power generated by the fuel cell power generator, so as to obtain an output voltage and an output power of the fuel cell power generator;
an electronic load circuit, coupled to the fuel cell power generator, capable of performing a current-sinking operation on the fuel cell power generator;
an external load power supply circuit, coupled to the fuel cell power generator, capable of receiving the power of the fuel cell power generator and supplying the power to an external load;
a secondary battery;
a charge module, coupled to the fuel cell power generator, capable of adjusting a charge current of the secondary battery; and
a control unit, coupled to the electronic load circuit, the external load power supply circuit, and the charge module, capable of controlling a sinking current of the electronic load circuit according to a detection result of the first state detecting unit, so as to adjust the output voltage of the fuel cell power generator, and capable of enabling at least one of the electronic load circuit, the external load power supply circuit, and the charge module according to the output power of the fuel cell power generator.

2. The fuel cell system according to claim 1, wherein the control unit enables the external load power supply circuit and disables the electronic load circuit and the charge module when the output power is equal to a rated power of the external load.

3. The fuel cell system according to claim 1, wherein the control unit enables the electronic load circuit and the charge module and disables the external load power supply circuit when the output power is less than a rated power of the external load.

4. The fuel cell system according to claim 1, wherein the control unit enables the electronic load circuit, the charge module, and the external load power supply circuit when the output power is greater than a rated power of the external load.

5. The fuel cell system according to claim 1, wherein the electronic load circuit comprises:
a first conversion unit, coupled to the control unit, capable of converting a first pulse width modulation signal output from the control unit into an analog voltage;
a first operational amplifier, having a positive input terminal coupled to an output terminal of the first conversion unit;
a first transistor, having a drain coupled to the fuel cell power generator and a source coupled to a negative input terminal of the first operational amplifier;
a first resistor, coupled between an output terminal of the first operational amplifier and a gate of the first transistor;
a second resistor, coupled between the source of the first transistor and a ground voltage; and
a third resistor, coupled between the output terminal of the first operational amplifier and the ground voltage.

6. The fuel cell system according to claim 5, wherein the control unit is capable of adjusting a duty cycle of the first pulse width modulation signal, so as to control a value of the analog voltage.

7. The fuel cell system according to claim 5, wherein the charge module comprises:
a charging circuit, coupled to the fuel cell power generator and the control unit, wherein the fuel cell power generator charges the secondary battery through the charging circuit when the charging circuit is enabled by the control unit; and
a control circuit, coupled to the charging circuit and the secondary battery, wherein the control circuit adjusts the charge current of the secondary battery when the control circuit is enabled by the control unit.

8. The fuel cell system according to claim 7, wherein the charge module further comprises:
an internal load power supply circuit, coupled to the secondary battery, capable of receiving an electric power stored in the secondary battery and supplying the electric power to an internal load of the fuel cell system.

9. The fuel cell system according to claim 7, wherein the charge module further comprises:
a second state detecting unit, coupled to the secondary battery and the control unit, capable of detecting a storage voltage of the secondary battery, wherein the control unit is capable of enabling the charge module according to the storage voltage of the secondary battery, so as to adjust the charge current of the secondary battery.

10. The fuel cell system according to claim 7, wherein the first conversion unit comprises:
a fourth resistor, coupled to the control unit;
a first capacitor, coupled between the fourth resistor and the ground voltage;
a fifth resistor, coupled between the fourth resistor and the output terminal of the first conversion unit; and
a second capacitor, coupled between the output terminal of the first conversion unit and the ground voltage.

11. The fuel cell system according to claim 7, wherein the control circuit comprises:
a second conversion unit, coupled to the control unit, capable of converting a second pulse width modulation signal output from the control unit into an analog voltage;
a second operational amplifier, having a positive input terminal coupled to the output terminal of the first conversion unit;
a second transistor, having a drain coupled to the charging circuit and a source coupled to the secondary battery;
a sixth resistor, coupled between an output terminal of the second operational amplifier and a gate of the second transistor;
a seventh resistor, coupled between a negative input terminal of the second operational amplifier and the gate of the second transistor;
an eighth resistor, coupled between the negative input terminal of the second operational amplifier and the ground voltage; and
a ninth resistor, coupled between the positive input terminal of the second operational amplifier and the ground voltage.

12. The fuel cell system according to claim 11, wherein the control unit is capable of adjusting a duty cycle of the second pulse width modulation signal, so as to control a value of the analog voltage.

13. The fuel cell system according to claim 11, wherein the second conversion unit comprises:
a tenth resistor, coupled to the control unit;
a third capacitor, coupled between the tenth resistor and the ground voltage;
an eleventh resistor, coupled between the tenth resistor and an output terminal of the second conversion unit; and
a fourth capacitor, coupled between the output terminal of the second conversion unit and the ground voltage.

14. A power management method of a fuel cell system, wherein the fuel cell system comprises a fuel cell power generator and a secondary battery, the power management method comprising:
(a) detecting whether a current-sinking operation is performed on the fuel cell power generator, detecting an output voltage of the fuel cell power generator, and adjusting a charge current of the secondary battery according to the output voltage;
(b) detecting the output voltage of the fuel cell power generator and comparing the output voltage with a predetermined operating voltage of the fuel cell power generator, and adjusting a sinking current of the fuel cell power generator according to a result of the comparison; and
(c) detecting an output power of the fuel cell power generator and comparing the output power with a rated power of an external load, and determining whether the fuel cell power generator supplies a power to the external load according to the result of the comparison.

15. The power management method according to claim 14, wherein the step of detecting whether the current-sinking operation is performed on the fuel cell power generator, detecting the output voltage of the fuel cell power generator, and adjusting the charge current of the secondary battery according to the output voltage comprises:
increasing the charge current of the secondary battery when the current-sinking operation is performed on the fuel cell power generator;
determining whether the output voltage falls within a predetermined voltage range when the current-sinking operation is not performed on the fuel cell power generator; and
decreasing the charge current of the secondary battery when the output voltage is lower than the predetermined voltage range.

16. The power management method according to claim 14, wherein the step of comparing the output voltage with the operating voltage and adjusting the sinking current of the fuel cell power generator according to the result of the comparison comprises:
determining whether the output voltage is greater than the operating voltage;
increasing the sinking current of the fuel cell power generator when the output voltage is greater than the operating voltage;
determining whether the output voltage is less than the operating voltage when the output voltage is not greater than the operating voltage; and
decreasing the sinking current of the fuel cell power generator when the output voltage is less than the operating voltage.

17. The power management method according to claim 14, wherein the step of comparing the output power with the rated power and determining whether the fuel cell power generator supplies the power to the external load according to the result of the comparison comprises:
determining whether the output power is greater than or equal to the rated power;
supplying the power to the external load through the fuel cell power generator when the output power is greater than or equal to the rated power; and
stopping supplying the power to the external load through the fuel cell power generator when the output power is less than the rated power.

18. The power management method according to claim 14, wherein the step (a), the step (b), and the step (c) are executed in sequence every a predetermined interval.
